(19) United States
(12) Patent Application Publication
(10) Pub. No.: US 2006/0023581 A1
(43) Pub. Date: Feb. 2, 2006

(54) Optical disk recording device and pickup device

(76) Inventors: Ryuichi Sunagawa, Gunma (JP); Katsuhiro Oyama, Gunma (JP); Fuyuki Miyazawa, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/173,387

(22) Filed: Jul. 1, 2005

(30) Foreign Application Priority Data
Jul. 6, 2004 (JP) 2004-199431

(51) Int. Cl. G11B 7/00

(52) U.S. Cl. 369/44.27; 369/47.36

(57) ABSTRACT

The invention provides an effective method for improving accuracy of recording, tracking, and reproduction in a real-time correction in which correction is performed simultaneously with recording. A beam spot for recording, beam spots for reproduction, and beam spots for tracking are formed by branching a laser beam outputted from a laser diode by using a diffraction grating. In this manner, by providing the beam spots for recording, reproduction, and tracking independently, signals which are subjected to less reproduction degradation are obtained while maintaining tracking accuracy.

### BACKGROUND OF THE INVENTION

1. Field of the Invention

The present invention relates to an optical disk recording device and a pickup device, and more specifically, to an optical disk recording device and a pickup device which are effective for correction of a registration condition in real time.

2. Description of the Related Art

Information record to an optical recording media such as an optical disk is performed by modulating recorded data in an EFM (Eight to Fourteen Modulation) system, forming a record pulse based on a modulating signal, controlling the strength or irradiation timing of a laser beam based on the record pulse, and forming a recording pit on the optical disk.

Formation of the recording pit in this case is performed by utilizing heat generated by irradiation of the laser beam, the record pulse is required to be set with a heat accumulation effect or heat interference, and the like taken into account.

Therefore, in the related art, recording on the optical disk has been performed by defining a plurality of settings of various parameters which constitute the record pulse for each type of the optical disk in a form of a strategy, and selecting one of these strategies which is optimal for the record environment.

Since the strategy depends not only on the individual difference among the optical disk recording devices such as variations in spot diameter of the pickup, variations in accuracy of the mechanism and the like, but also on manufacturers and types and the record speed of the optical disk used for record reproduction, setting of the optimal strategy may result in improvement of the recording quality.

Therefore, a method of finding the optimal strategies for the optical disks corresponding to the respective manufacturers and types, storing the results corresponding to the respective manufacturers and types in a memory in advance, and when recording information on the optical disk, reading manufacturers and types of the optical disk stored in the optical disk, and reading the optimal strategy corresponding to the read manufacturers and types from the memory to use is proposed.

However, according to the above-described method, although the optimal recording is achieved for the optical disk of manufactures and types stored in the memory in advance, the optimal recording cannot be achieved for the optical disk of manufacturers and types which are not recorded in the memory. In addition, even with the optical disk of manufacturers and types which are stored in the memory in advance, the optimal recording cannot be achieved if the record speed is different.

Accordingly, as disclosed in JP-A-5-144001, JP-A-4-137224, JP-A-5-143999 and JP-A-7-235056 shown below, a plurality of methods which can cope with various types of optical disks by conducting a test record in advance for each registration condition and determining the optimal strategy based on the test record are proposed.

However, in the methods shown in JP-A-5-144001, JP-A-4-137224, JP-A-5-143999 and JP-A-7-235056, since it is necessary to perform the test record before starting information record, the strategy cannot be corrected simultaneously with recording, and hence it is difficult to cope with the case in which the optimal condition is different between the outer periphery and the inner periphery.

Since there is such a problem, that is, the fact that the storage characteristic of the optical disk is slightly different from the inner periphery to the outer periphery, and that the recording rate is different between the inner periphery and the outer periphery on the side of the record device, a technology to alleviate the difference between the inner periphery and the outer periphery by adjusting the laser output is shown in the following publications as a technology to solve the problem such that there arises a difference in recording quality between the inner periphery and the outer periphery.

In JP-A-53-050707 and JP-A-2001-312822, a technology to optimize the laser output automatically by detecting the quantity of light change of the supplementary beam is disclosed, and the method of this type is referred to as OPC.

Since the OPC as described above is a method of adjusting power, the correction conditions can be found with a statistic index such as an asymmetric value, and a real-time correction which performs correction while recording is also possible. However, in a case in which the pulse width or the phase conditions of the pulse are to be corrected, it is necessary to detect the amount of displacement between the record pulse and the pit formed on the optical disk, and hence it is difficult to cope with this case with the conventional OPC.

Therefore, in order to perform the real-time correction of the pulse conditions, a technology to detect the position and the length of the pit simultaneously with recording is necessary.

As an approach for this necessity, a method of reproducing simultaneously with recording by employing a beam for recording and a beam for reproduction independently is disclosed in JP-A-7-129956 and JP-A-9-147361.

In JP-A-7-129956, a method of recording with a main beam and reproducing with a sub-beam is disclosed, and in JP-A-9-147361, a method of recording with a main beam and reproducing and tracking with a sub-beam is disclosed.

However, in the method disclosed in JP-A-7-129956, tracking is not taken into consideration, and in the method disclosed in JP-A-9-147361, since reproduction is performed using a beam arranged on a boundary between a land and a groove for tracking, deterioration of a regenerative signal during tracking can easily be occurred.

### SUMMARY OF THE INVENTION

Accordingly, the present invention provides a method effective in improvement of accuracy of recording, tracking and reproduction in the real-time correction for correcting the registration condition simultaneously with recording.

In order to achieve the above-described object, a first aspect of the invention is an optical disk recording device for forming a pit on an optical recording media by a pulse irradiation of a laser beam for recording and simultaneously, detecting the pit by irradiation of a laser beam for reproduction, characterized in that tracking of the laser beam for recording and the laser beam for reproduction is performed by irradiating a laser beam for tracking on the media in addition to the laser beam for recording and the laser beam for reproduction.

In this manner, by providing the laser beam for reproduction and the laser beam for tracking separately, reproduction with less signal deterioration is achieved while performing tracking.

Tracking objects here are the laser beam for recording and the laser beam for reproduction, and preferably, both of these laser beams are determined as the tracking objects.

The method of tracking may be any one of a known three beam technique or a differential push-pull method.

A second aspect of the invention is an optical disk recording device for generating a laser beam for recording and a laser beam for reproduction by branching one laser beam, forming a pit on an optical recording media by pulse irradiation of the laser beam for recording, and detecting the pit by irradiating the laser beam for reproduction, characterized in that tracking of the one laser beam is performed by further branching the one laser beam to generate a laser beam for tracking and irradiating the laser beam for tracking on to the media.

In this manner, when employing a branch configuration, tracking of the laser beam for recording and the laser beam for reproduction can be substantially achieved by generating the laser beam for tracking by branching and determining the one laser beam which corresponds to a branching source as the tracking object.

As information as a basis of the tracking, any of reflective light of the laser beam for recording and reflective light of the laser beam for reproduction may be used.

The one laser beam here includes a laser beam which becomes a source when the laser beam irradiated from the specific light source is branched in several steps. In other words, a case in which the laser beam for recording and the laser beam for reproduction are generated from a certain laser beam via an intermediate branching step is also included.

A third aspect of the invention is an optical disk recording device for generating a pit on an optical recording media by pulse irradiation of a laser beam for recording and simultaneously, detecting the pit by irradiating a laser beam for reproduction, characterized in that a distance H between a recording spot formed on the media by irradiating the laser beam for recording and a reproduction spot formed on the media by irradiating the laser beam for reproduction is determined by an expression H≧V×T, where T represents a time required for forming the pit, and V represents a linear velocity of the media.

As described above, the pit of the final state in which an influence of a record environment is reflected can be regenerated by arranging the recording spot and the reproduction spot while taking a pit formation time into consideration, the real-time correction with higher degree of accuracy is realized.

The time required for forming the pit is preferably determined by considering the relation between heat characteristics of a recording material and registration conditions in the case of dye type media, and is determined by considering phase change characteristics of an inorganic material in the case of phase change type media. More preferably, it is defined in advance for each pit length by testing a plurality of types of media.

A fourth aspect of the invention is a pickup device which receives and processes first and second beam spots irradiated on an optical recording media via an objective lens, a collimating lens, and a toroidal lens via the first and second detectors respectively, characterized in that where Y1 represents a distance between the first and second beam spots in the vertical direction of optical axis, X1 represents a distance between the same in the horizontal direction of optical axis, Ly represents a distance between the first and second detectors in the vertical direction of optical axis, Lx represents a distance between the same in the horizontal direction of optical axis, f1 represents a focal distance of the objective lens, f2 represents a focal distance of the collimating lens, f3y represents a focal distance of the toroidal lens in the vertical direction, f3x represents a focal distance thereof in the horizontal direction, f3 is a focal distance synthesized by f3x and f3y and d represents a distance between principal points of the collimating lens and the toroidal lens, and when the aforementioned Y2 and X2 are defined by following expression:
Y2={f1·f2·f3y/(f2+f3−d)}·Y1
X2={f1·f2−f3x/(f2+f3−d)}·X1,
if the toroidal lens is a convex lens, and f3y>f3x is satisfied, the aforementioned Y2, X2, Ly, X2 satisfy relations Y2>Ly and X2<Lx.

As described above, by providing conditions which satisfy the relations Y2>Ly and X2<Lx when the toroidal lens is the convex lens, mechanical overlapping of the first and second detectors can be avoided.

More specifically, when Wy represents the width of the first and second detectors in the vertical direction of optical axis and Wx represents the width of the same in the horizontal direction of optical axis, arrangement under the conditions in which the aforementioned Lx and Wx satisfy a relation Lx≧Wx is preferred, and a detection side of the first detector and a detection side of the second detector are arranged on different Z-coordinates, where Y-axis represents the vertical direction of the optical axis, X-axis represents the horizontal direction of optical axis, and Z-axis represents the direction of optical axis.

A fifth aspect of the invention is a pickup device which receives and processes first and second beam spots irradiated on an optical recording media via an objective lens, a collimating lens, and a toroidal lens via the first and second detectors respectively, characterized in that where Y1 represents a distance between the first and second beam spots in the vertical direction of optical axis, X1 represents a distance between the same in the horizontal direction of optical axis, Ly represents a distance between the first and second detectors in the vertical direction of optical axis, Lx represents a distance between the same in the horizontal direction of optical axis, f1 represents a focal distance of the objective lens, f2 represents a focal distance of the collimating lens, f3y represents a focal distance of the toroidal lens in the vertical direction, f3x represents a focal distance thereof in the horizontal direction, f3 is a focal distance synthesized by f3x and f3y, and d represents a distance between principal points of the collimating lens and the toroidal lens, and when the aforementioned Y2 and X2 are defined by following expression:
Y2={f1·f2·f3y/(f2+f3−d)}·Y1
X2={f1·f2·f3x/(f2+f3−d)}·X1,
if the toroidal lens is a concave lens, and f3y>f3x is satisfied, the aforementioned Y2, X2, Ly, X2 satisfy relations Y2<Ly and X2>Lx.

As described above, by providing conditions which satisfy the relations Y2<Ly and X2>Lx when the toroidal lens is a concave lens, mechanical overlapping of the first and second detectors can be avoided.

More specifically, when Wy represents the width of the first and second detectors in the vertical direction of optical axis and Wx represents the width of the same in the horizontal direction of optical axis, arrangement under the conditions in which the aforementioned Ly and Wy satisfy a relation Ly≧Wy is preferred, and a detection side of the first detector and a detection side of the second detector are arranged on different Z-coordinates, where Y-axis represents the vertical direction of the optical axis, X-axis represents the horizontal direction of optical axis, and Z-axis represents the direction of optical axis.

A sixth aspect of the invention is a pickup device which receives and processes a beam spot irradiated on an optical recording media by a detector, via an objective lens a collimating lens, and a toroidal lens, characterized in that where dy represents a distance between an image surface of the beam spot in the vertical direction and a principal point of the toroidal lens, dx represents a distance between an image surface of the beam spot in the horizontal direction and the principal point of the toroidal lens, and D represents a distance between the detection side of the detector and the principal point of the toroidal lens, if the toroidal lens is a convex lens, and f3y>f3x is satisfied, the aforementioned dx, dy, and D satisfy a relation dx<D<dy.

As described above, by providing conditions which satisfy the relation dx<D<dy when the toroidal lens is the convex lens, the detector can be arranged in a range in which an astigmatism method can be implemented.

In this case, the image surface in the horizontal direction represents a focusing position at which a spot width in the horizontal direction becomes minimum, and the image surface in the vertical direction represents a focusing position where the spot width in the vertical direction becomes minimum.

A seventh aspect of the invention is a pickup device which receives and processes a beam spot irradiated on an optical recording media via an objective lens, a collimating lens, and a toroidal lens by a detector, characterized in that where dy represents a distance between an image surface in the vertical direction of the beam spot and a principal point of the toroidal lens, dx represents a distance between the image surface in the horizontal direction of the beam spot and the principal point of the toroidal lens, and D represents a distance between a detection side of the detector and the principal point of the toroidal lens, if the toroidal lens is a concave lens, and f3y>f3x is satisfied, the aforementioned dx, dy, and D satisfy a relation dx>D>dy.

As described above, by providing conditions which satisfy the relation dx>D>dy when the toroidal lens is the concave lens, the detector can be arranged in a range in which an astigmatism method can be implemented.

As described above, according to the invention, since the tracking and reproduction are performed independently, the real-time correction with higher degree of accuracy is achieved.

The invention is not limited to embodiments described below, and may be modified as needed.

### BRIEF DESCRIPTION OF THE DRAWINGS

FIG. 1 is a block diagram showing an internal composition of a drive according to the present invention;

FIG. 2 is an exploded perspective view showing a structure of a pickup built in the drive shown in FIG. 1;

FIG. 3 is a plan view showing an arrangement of spots irradiated on a disk surface of an optical disk;

FIG. 4 shows a conceptual diagram showing a relation between the spot irradiated on the disk surface of the optical disk and a detector;

FIG. 5 is a conceptual diagram showing a relation between the respective spots and the detector in the case of irradiating four spots on the disk surface of the optical disk;

FIG. 6 is a conceptual diagram showing a relation between the respective spots and the detector in the case of irradiating nine spots on the disk surface of the optical disk;

FIG. 7 is a plan view showing a distance between a beam for recording and a beam for reproduction;

FIG. 8 is an exploded perspective view showing a positional relation of the respective optical elements provided in the pickup shown in FIG. 1;

FIG. 9 is a conceptual diagram showing a relation between vertical and horizontal layouts of an objective lens 118, a collimating lens 119, and a toroidal lens 120, and distances between the respective detectors;

FIG. 10 is a perspective diagram showing an example of arrangement of a first detector and a second detector;

FIG. 11 is a conceptual diagram showing an image of ranges of maximum distance between the detectors;

FIG. 12 is a perspective diagram showing the relation between the width and the distance of the first and second detectors;

FIG. 13 is a perspective diagram showing an example of another arrangement of the first detector and the second detector;

FIG. 14 is a conceptual diagram showing a relation between the vertical and horizontal layouts of the objective lens 118, the collimating lens 119, and the toroidal lens 120 shown in FIG. 8 and the position of the detectors in the direction of optical axis;

FIG. 15 is a conceptual diagram showing a concept of focusing using an astigmatism method;

FIG. 16 is a circuit block diagram showing an internal composition of a pulse generation circuit shown in FIG. 1;

FIG. 17 is a circuit drawing showing an internal composition of a LD driver shown in FIG. 1;

FIG. 18 is a timing chart showing a process of generation of a record pulse shown in FIG. 17; and

FIG. 19 is a timing chart showing a relation between a main beam for recording and a sub-beam for reproduction.

### DESCRIPTION OF THE PREFERRED EMBODIMENTS

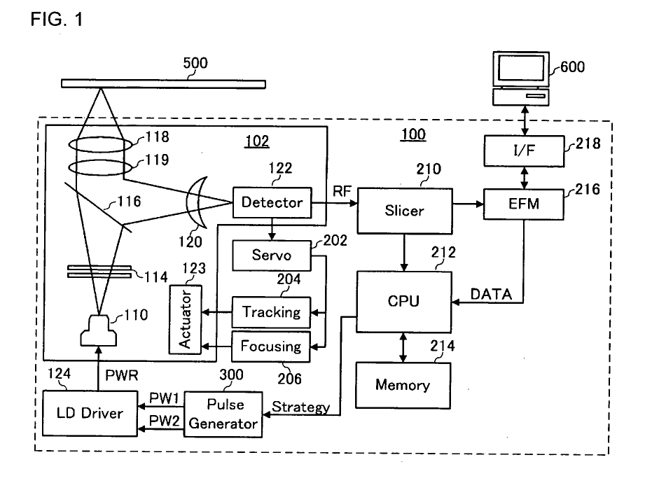

FIG. 1 is a block diagram showing an internal composition of a drive according to the present invention.

As shown in the same drawing, a drive 100 performs record reproduction of information on an optical disc 500 using a laser beam outputted from a laser diode 110, and transmits and receives data with respect to an external device such as a personal computer 600 or the like.

When recording the information on the optical disk 500, a strategy which corresponds to registration conditions for the optical disk 500 is determined by encoding recorded data received from the personal computer 600 via an interface circuit 218 by an EFM encoder/decoder 216, and processing the encoded recorded data by a CPU 212, the strategy is converted into a record pulse in a pulse generation circuit 300, and the record pulse is outputted to a LD driver 124.

A LD driver 124 drives the laser diode 110 based on the inputted record pulse, the laser diode 110 controls the output laser beam corresponding to the record pulse, and irradiates the controlled laser beam via a diffraction grating 114, a polarized beam splitter 116, and an objective lens 118 onto the optical disk 500 which rotates at a constant linear velocity or at a constant rotary velocity, whereby a record pattern including pit and land rows corresponding to a desired recorded data is recorded on the optical disk 500.

On the other hand, when reproducing information recorded on the optical disk 500, a reproduction laser beam is irradiated on the optical disk 500 via the diffraction grating 114, the polarized beam splitter 116, and the objective lens 118 from the laser diode 110.

At this time, a laser beam which is low in strength than the laser beam used at the time of recording is used as the reproduction laser beam, reflective light of the reproduction laser beam from the optical disk 500 is received by a detector 122 via the objective lens 118, the polarized beam splitter 116, the toroidal lens 120, thereby being converted into an electrical signal.

The electrical signal outputted from the detector 122 corresponds to the record pattern including pits and lands recorded on the optical disk 500, and the electrical signal is binarized by a slicer 210, then decoded by the EFM encoder/decoder 216, and then outputted as the regenerative signal.

A pickup 102 includes optical elements such as the above-described laser diode 110, the diffraction grating 114, the polarized beam splitter 116, the objective lens 118, the collimating lens 119, the toroidal lens 120, the detector 122, and the optical elements provided in the pickup are driven by an actuator 123.

The control positions of the respective optical elements are detected by a servo detecting unit 202 and, based on the detection results of the servo detecting unit 202, a tracking control unit 204 drives the actuator 123 to perform tracking control, and a focusing control unit 206 drives the actuator 123 to perform focusing control.

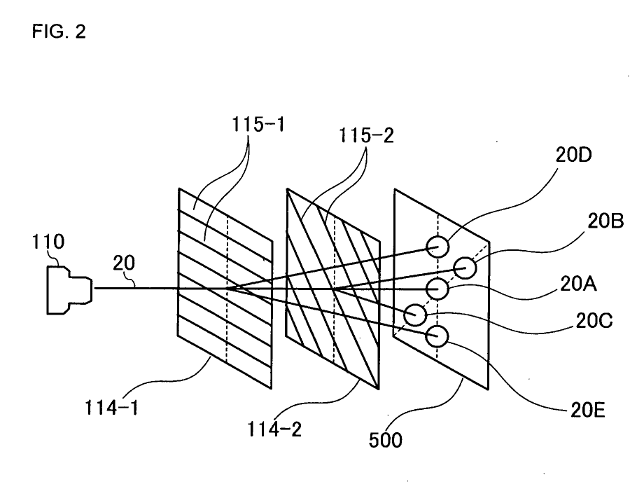

FIG. 2 is an exploded perspective view showing a structure of a pickup built in the drive shown in FIG. 1.

As shown in FIG. 2, the diffraction grating provided between the laser diode 110 and a disc surface of the optical disk 500 includes two diffraction gratings 114-1, 114-2, and the respective diffraction gratings are formed with grooves 115-1, 115-2 extending in the different directions, respectively.

When a laser beam 20 enters the diffraction gratings configured as described above, the laser beam is branched into three laser beams by the first diffraction grating 115-1, and then branched further into three laser beams by the second diffraction grating 115-2, whereby nine laser beams in total are formed. Then, five spots 20A to 20E out of these beams which are irradiated on the disk surface of the optical disk are used.

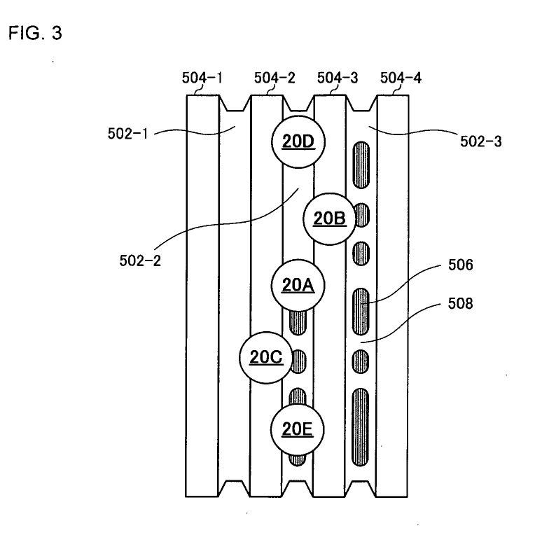

FIG. 3 is a plan view showing an arrangement of spots irradiated on the disk surface of the optical disk.

As shown in FIG. 3, a main beam for recording 20A, a precedent sub-beam for tracking 20B, a following sub-beam for tracking 20C, a precedent sub-beam for reproduction 20D, and a following sub-beam for reproduction 20E are irradiated on the disk surface of the optical disk 500.

Here, the main beam for recording 20A is irradiated on a groove 502-2 formed on the optical disk 500, and by this irradiation of the beam spot, pits 506 are formed in the groove 502-2.

The main beam for recording 20A is set to the highest luminescence intensity to enable formation of a pit by a heat mode.

The precedent sub-beam for tracking 20B is irradiated on a land 504-3 which is situated next to the groove 502-2 on which the main beam 20A is irradiated, and the following sub-beam for tracking 20C is irradiated on a land 504-2 which is a land situated next to the groove 502-2 on which the main beam 20A is irradiated, that is, the land on the opposite side from the land on which the sub-beam 20B is irradiated.

The precedent sub-beam for reproduction 20D is irradiated on the groove 502-2 which is the same groove on which the main beam 20A is irradiated at a position preceding the main beam 20A, and the following sub-beam for reproduction 20E is irradiated on the groove 502-2 which is the same as the groove on which the main beam 20A is irradiated at a position following the main beam 20A.

By disposing the respective spots as described above, the record pattern formed by the main beam 20A, that is, the record pattern composed of combination of the pit 506 and a land 508 can be detected by the following sub-beam for reproduction 20E.

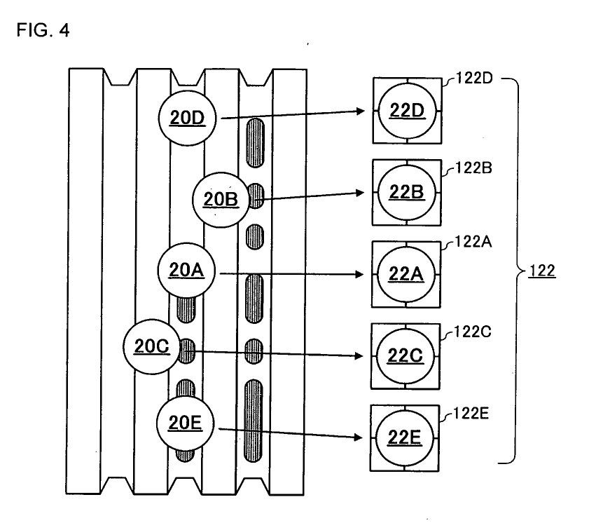

FIG. 4 shows a conceptual diagram showing a relation between the spot irradiated on the disk surface of the optical disk and the detector. As shown in FIG. 4, the detector 122 shown in FIG. 1 includes five light receiving portions from 122A to 122E, and reflective lights 22A to 22E corresponding to the spots 20A to 20E are irradiated on the respective light receiving portions, thereby being converted into the electrical signals.

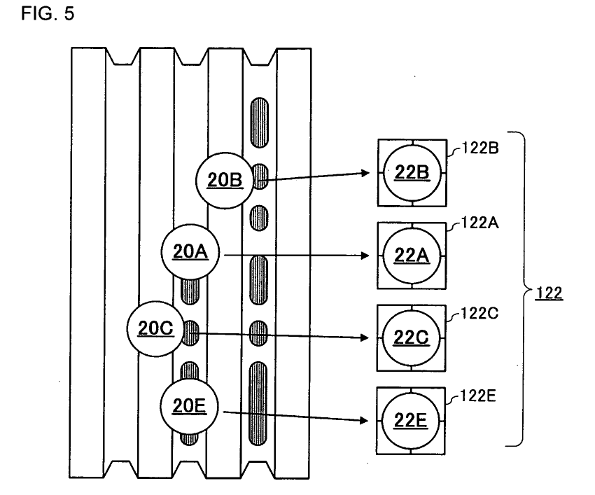

FIG. 5 is a conceptual diagram showing a relation between the respective spots and the detector in the case of irradiating four spots on the disk surface of the optical disk. As shown in FIG. 5, the invention may be configured without using the precedent sub-beam for reproduction 20D shown in FIG. 4.

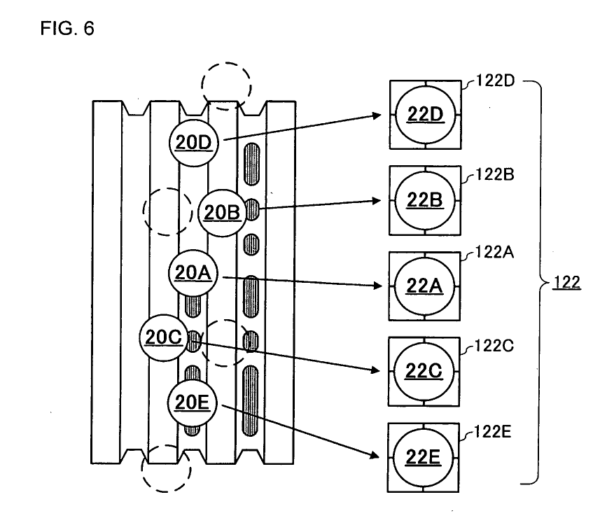

FIG. 6 is a conceptual diagram showing a relation between the respective spots and the detector in the case of irradiating nine spots on the disk surface of the optical disk.

As shown in FIG. 6, the invention may be configured to generate nine branched lights by the diffraction grating and use five of them.

In this case, a configuration in which spots shown in broken lines in the drawing are not received by the detector is employed.

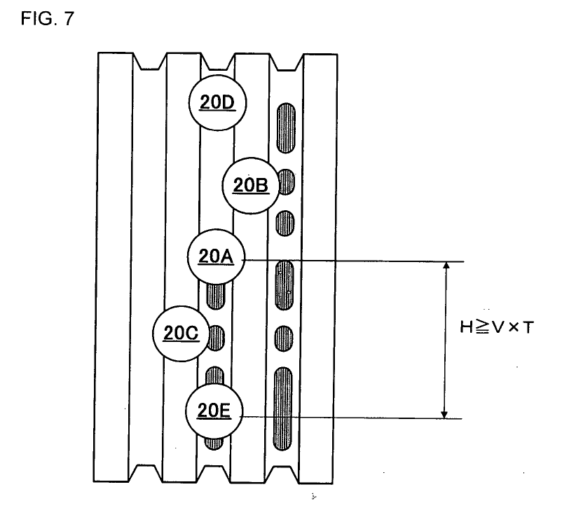

FIG. 7 is a plan view showing a distance between the beam for recording and the beam for reproduction.

As shown in FIG. 7, a distance H between the main beam for recording 20A and the sub-beam for reproduction 20E is set to a range of H≧V×T, where T represents a time required for formation of a pit, and V represents a linear velocity of the media.

This configuration is devised by focusing attention to a point that there arises a problem such that passage of time until completion of recording is necessary in the optical recording media, and hence in a state of imperfect recording, the laser output and the regenerative signal for pulse adjustment are deteriorated, and a distance between the beam spot for recording and the beam spot for reproduction is determined in order to avoid the regenerative signal acquisition in the state of incomplete recording as described above.

While media using thermal reaction or phase change for data recording are known in the optical recording media, by setting the distance between the record spot and the regenerative signal acquisition spot on the optical recording medium as shown in FIG. 7, acquisition of regenerative signals after completion of data recording is ensured.

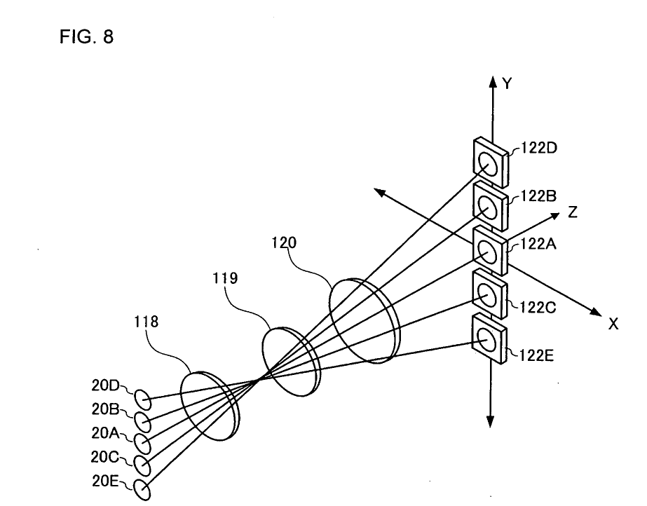

FIG. 8 is an exploded perspective view showing a positional relation of the respective optical elements provided in the pickup shown in FIG. 1.

As shown in FIG. 8, when Y-axis represents the vertical direction of optical axis, X-axis represents the horizontal direction of optical axis, and the Z-axis represents the direction of optical axis, the objective lens 118, the collimating lens 119, and the toroidal lens 120 are disposed on the Z-axis and the detectors 122A-122E are disposed on the Y-axis.

In this arrangement, the spots 20A to 20E irradiated on the disk surface of the optical disk are irradiated on the detection sides of the respective detectors via the objective lens 118, the collimating lens 119, and the toroidal lens 120.

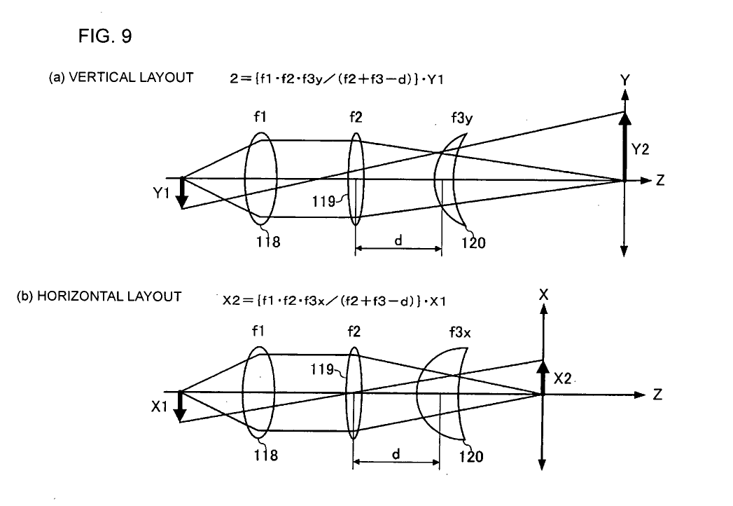

FIG. 9 is a conceptual diagram showing a relation between vertical and horizontal layouts of the objective lens 118, the collimating lens 119, and the toroidal lens 120, and the distances between the respective detectors. FIG. 9A shows a vertical layout of the respective optical elements, and FIG. 9B shows a horizontal layout of the respective optical elements.

As indicated in the respective drawings, where Y1 represents a distance between the first and second beam spots in the vertical direction of optical axis, X1 represents a distance between the same in the horizontal direction of optical axis, Ly represents a distance between the first and second detectors in the vertical direction of optical axis, Lx represents a distance between the same in the horizontal direction of optical axis, f1 represents a focal distance of the objective lens, f2 represents a focal distance of the collimating lens, f3y represents a focal distance of the toroidal lens in the vertical direction, f3x represents a focal distance between the same in the same horizontal direction, f3 is a focal distance synthesized by f3x and f3y and d represents a distance between principal points of the collimating lens and the toroidal lens, Y2 and X2 are defined by following expression.
Y2={f1·f2·f3y/(f2+f3−d)}·Y1
X2={f1·f2·f3x/(f2+f3−d)}·X1

Therefore, when the toroidal lens is a convex lens and f3y>f3x, the first and second detectors are arranged under conditions where Y2>Ly and X2<Lx are satisfied, while when the toroidal lens is a concave lens and f3y>f3x is satisfied, the first and second detectors are arranged under conditions where Y2<Ly and X2>Lx are satisfied.

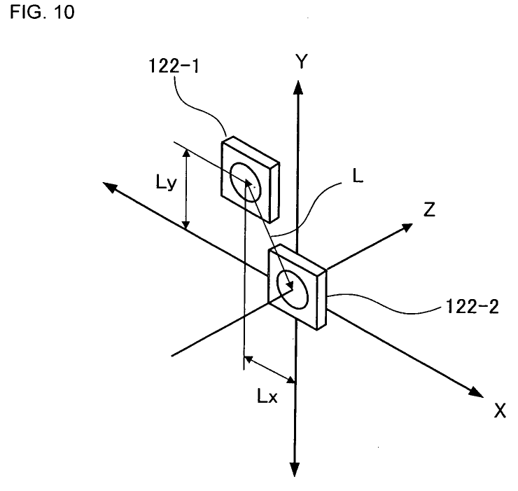

FIG. 10 is a perspective diagram showing an example of arrangement of the first detector and the second detector.

As shown in FIG. 10, imaging a case in which a first detector 122-1 and a second detector 122-2 are disposed obliquely on a XY plane, a distance L between the respective detectors is set to a distance larger than Lx and Ly, thereby achieving a configuration in which the respective detectors are prevented from being mechanically overlapped with each other, and light receiving of the spots is enabled.

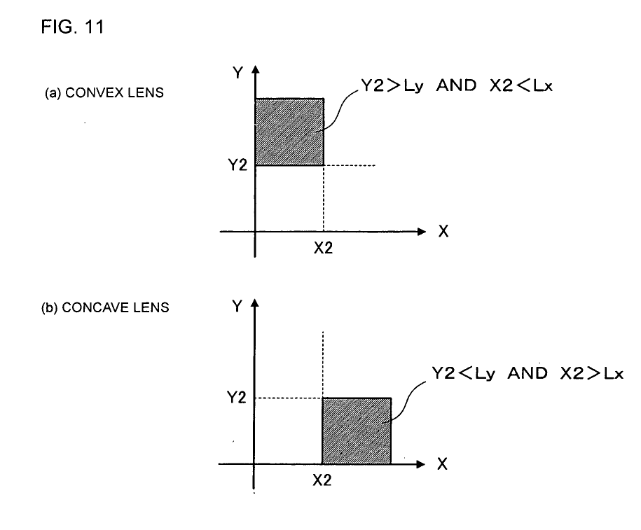

FIG. 11 is a conceptual diagram showing an image of ranges of maximum distance between the detectors.

As shown in the respective drawings, when the toroidal lens is a convex lens, the distance between the detectors are to be in the range shown in FIG. 11A, and when the toroidal lens is the concave lens, the distance between the detectors are to be in the range shown in FIG. 11B.

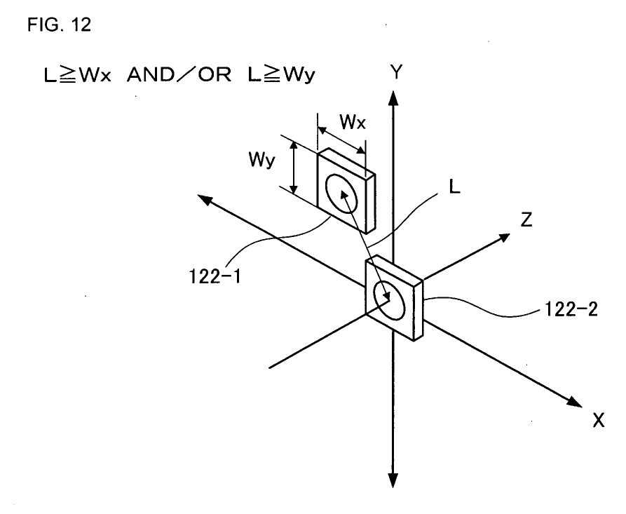

FIG. 12 is a perspective diagram showing the relation between the width and the distance of the first and second detectors.

As shown in FIG. 12, when Wy represents the width of the first and second detectors in the vertical direction of optical axis and Wx represents the width of the same in the horizontal direction of optical axis, a configuration in which the respective detectors are prevented from being mechanically overlapped with the each other, and light receiving of the spots is enabled is achieved with the arrangement under conditions which satisfy Ly≧Wy in the case of the concave lens and Lx>Wx in the case of the convex lens.

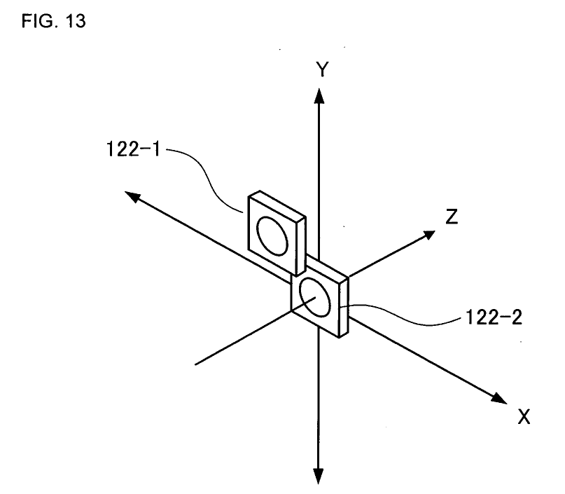

FIG. 13 is a perspective diagram showing an example of another arrangement of the first detector and the second detector.

As shown in FIG. 13, when the detection side of the first detector 122-1 and the detection side of the second detector 122-2 are arranged on different Z-coordinate, even when it is overlapped in a plane, spatial overlapping can be avoided, thereby achieving a configuration in which the respective detectors are prevented from being mechanically overlapped with each other, and light receiving of the spots is enabled.

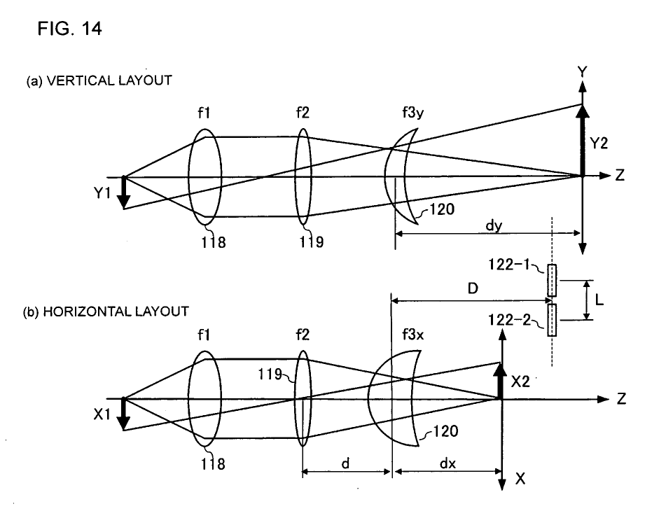

FIG. 14 is a conceptual diagram showing a relation between the vertical and horizontal layouts of the objective lens 118, the collimating lens 119, and the toroidal lens 120 shown in FIG. 8 and the position of the detectors in the direction of optical axis.

As shown in FIG. 14, when dy represents a distance between the image surface of the beam spot-in the vertical direction and the principal point of the toroidal lens, dx represents a distance between the image surface in the horizontal direction of the beam spot and the principal point of the toroidal lens, and D represents the distance between the detection side of the first and second detectors and the principal point of the toroidal lens, if the toroidal lens is a convex lens, and f3y>f3x is satisfied, the respective detectors are arranged under conditions where dx<D<dy is satisfied, and when the toroidal lens is a concave lens and f3y>f3x is satisfied, the respective detectors are arranged under conditions where dx>D>dy is satisfied.

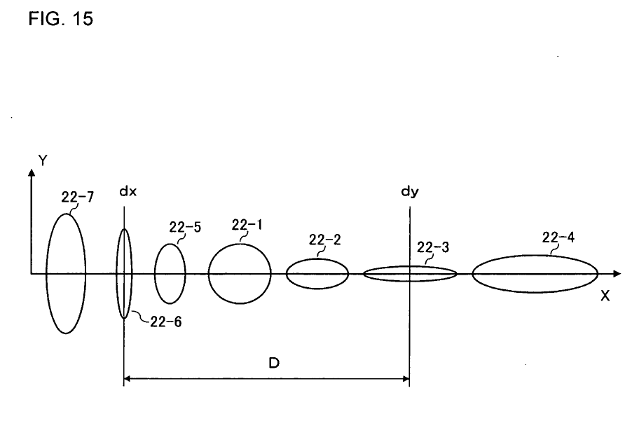

FIG. 15 is a conceptual diagram showing a concept of focusing using an astigmatism method.

As shown in FIG. 15, a reflection spot 22 irradiated on the detection side of the detector assumes a shape as shown by 22-1 to 22-7 according to the adjusted position of focusing, and a range from 22-6 which is an image surface in the horizontal direction to 22-3 which is an image surface in the vertical direction is a range in which the astigmatism method can be conducted.

Therefore, when performing focusing using the astigmatism method, the respective detectors are arranged between dx and dy.

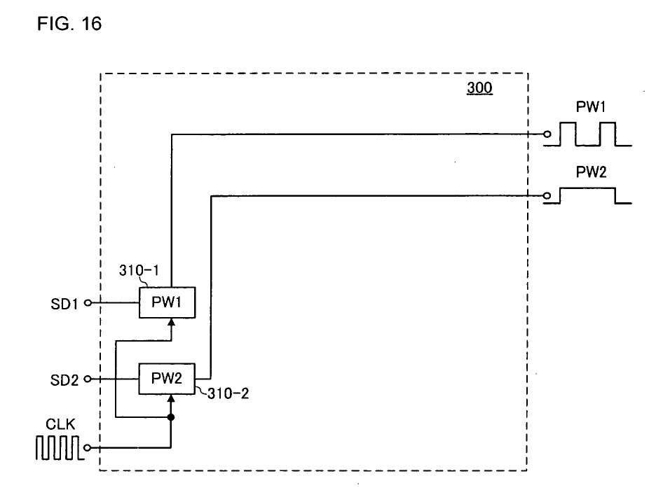

FIG. 16 is a circuit block diagram showing an internal composition of the pulse generation circuit shown in FIG. 1.

As shown in FIG. 16, in a pulse generation circuit 300, strategy conditions SD1, SD2 sent from the CPU 212 in FIG. 1 are received respectively in a pulse unit generation circuits 310-1, 310-2, and pulse signals PW1, PW2 synchronized with a clock signal CLK are generated.

The strategy conditions SD1, SD2 are defined as numerical value data representing the length of ON-period and OFF-period of the pulse by clock numbers, and the pulse unit generation circuits 310-1, 310-2 receiving these data generate pulse signals under conditions indicated by the strategy conditions SD1, SD2 using the clock signal CLK generated in the drive. These pulse signals PW1, PW2 are outputted to the LD driver 124 in FIG. 1.

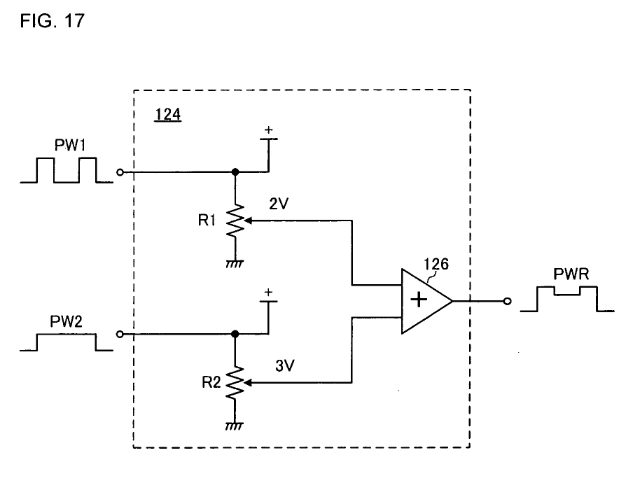

FIG. 17 is a circuit drawing showing an internal composition of the LD driver shown in FIG. 1.

As shown in FIG. 17, the LD driver 124 includes a partial pressure circuit using resistances R1, R2, and a synthesizer 126 for synthesizing the output voltages therefrom. The pulse signals PW1, PW2 from the pulse generation circuit 300 are amplified to a predetermined output level via the resistances R1, R2, and then synthesized in a logical addition manner by the synthesizer 126. Accordingly, a record pulse PWR is generated and outputted to the laser diode 110 in FIG. 1.

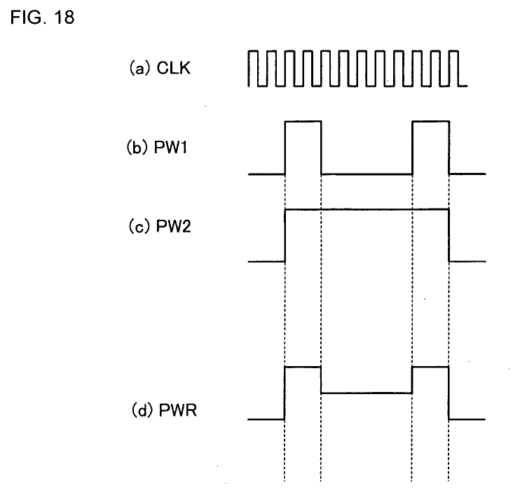

FIG. 18 is a timing chart showing a process of generation of the record pulse shown in FIG. 17.

As shown in the respective drawings, the record pulse PWR outputted to the laser diode is generated using the pulse signals PW1, PW2 which constitute the record pulse. In other words, as shown in FIG. 18B and 18C, the pulse signals PW1, PW2 are generated synchronously with the clock signal CLK in FIG. 18A, and as shown in FIG. 18D, the record pulse PWR is generated by synthesizing these pulse signals PW1, PW2.

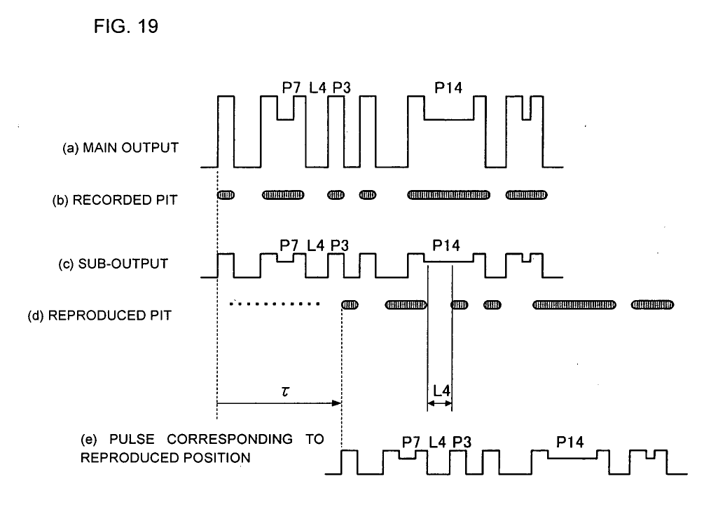

FIG. 19 is a timing chart showing a relation between the main beam for recording and the sub-beam for reproduction. As shown in FIG. 19A, the output of the main beam for recording assumes a pulse pattern of a high output required for formation of the pit, and the pit pattern formed on the optical disk by the pulse irradiation will be as shown in FIG. 19B.

On the other hand, as shown in FIG. 19C, the output of the sub-beam for reproduction is the same timing as the output pattern of the main beam for recording, thereby becoming a pulse pattern in which the output is reduced by an amount corresponding to a branching fraction with respect to the main beam for recording. Therefore, the pit pattern reproduced by the sub-beam for reproduction will be a pattern delayed by a time difference τ from the pit which is being recorded as shown in FIG. 19D.

Therefore, for example, when detecting a land 4T reproduced during recording of a pit 14T, as shown in FIG. 19E, a position where the land 4T of the pulse obtained by delaying the pattern of the record pulse by the time difference τ and a constant output area of the pit 14T of the record pulse overlap with each other may be specified.

In other words, a configuration of generating a first gate signal from the constant output area of the longer pit in the record pulse and generating a second gate signal from the pulse corresponding to the short pit or the land as the detection objects in the pulse pattern obtained by delaying the record pulse by the time difference τ, and then masking an RF signal obtained from the sub-beam for reproduction using the first and second gate signals becomes effective.

According to the invention, since the real-time correction with higher degree of accuracy is enabled, application to the record environment in which the registration condition is different between the inner periphery and the outer periphery of the optical disk is expected.

What is claimed is:

1. An optical disk recording device for recording information on an optical recording media by a pulse irradiation of a laser beam for recording and simultaneously, detecting the information by irradiation of a laser beam for reproduction, wherein tracking of the laser beam for recording and/or the laser beam for reproduction is performed by irradiating a laser beam for tracking on the media simultaneously with the laser beam for recording and the laser beam for reproduction.

2. The optical disk recording device as claimed in claim 1, wherein the laser beam for tracking is formed by branching one laser beam to generate a laser beam for tracking and irradiating the laser beam for tracking on to the media.

3. The optical disk recording device as claimed in claim 1, wherein a distance H between a recording spot formed on the media by irradiating the laser beam for recording and a reproduction spot formed on the media by irradiating the laser beam for reproduction is determined by an expression H≧V×T, where T represents a time required for forming a pit, and V represents a linear velocity of the media.

4. A pickup device which receives and processes first and second beam spots irradiated on an optical recording media via an objective lens, a collimating lens, and a toroidal lens via the first and second detectors respectively, wherein Y1 represents a distance between the first and second beam spots in the vertical direction of optical axis, X1 represents a distance between the same in the horizontal direction of optical axis, Ly represents a distance between the first and second detectors in the vertical direction of optical axis, Lx represents a distance between the same in the horizontal direction of optical axis, f1 represents a focal distance of the objective lens, f2 represents a focal distance of the collimating lens, f3y represents a focal distance of the toroidal lens in the vertical direction, f3x represents a focal distance thereof in the horizontal direction,f3 is a focal distance synthesized by f3x and f3y, and d represents a distance between principal points of the collimating lens and the toroidal lens, and when the aforementioned Y2 and X2 are defined by the following expressions:
Y2={f1·f2·f3y/(f2+f3−d)}·Y1
X2={f1·f2·f3x/(f2+f3−d)}·X1,
wherein the toroidal lens is a convex lens and f3y>f3x , the aforementioned Y2, X2, Ly, and Lx satisfy relations Y2>Ly and X2<Lx.

5. The pickup device according to claim 4 characterized by being configured under conditions where the aforementioned Lx and Wx satisfy a relation Lx≧Wx where Wx represents the width of the first and second detectors in the horizontal direction of optical axis.

6. The pickup device according to claim 4, characterized in that a detection side of the first detector and a detection side of the second detector are arranged on different Z-coordinates, where Y-axis represents the vertical direction of the optical axis, X-axis represents the horizontal direction of optical axis, and Z-axis represents the direction of optical axis.

7. A pickup device which receives and processes first and second beam spots irradiated on an optical recording media via an objective lens, a collimating lens, and a toroidal lens via the first and second detectors respectively, characterized in that where Y1 represents a distance between the first and second beam spots in the vertical direction of optical axis, X1 represents a distance between the same in the horizontal direction of optical axis, Ly represents a distance between the first and second detectors in the vertical direction of optical axis, Lx represents a distance between the same in the horizontal direction of optical axis, f1 represents a focal distance of the objective lens, f2 represents a focal distance of the collimating lens, f3y represents a focal distance of the toroidal lens in the vertical direction, f3x represents a focal distance thereof in the horizontal direction, f3 is a focal distance synthesized by f3x and f3y, and d represents a distance between principal points of the collimating lens and the toroidal lens, and when the aforementioned Y2 and X2 are defined by the following expressions:
Y2={f1·f2·f3y/(f2+f3−d)}·Y1
X2={f1·f2·f3x/(f2+f3−d)}·X1,
wherein the toroidal lens is a concave lens, f3y>f3x, and wherein Y2, X2, Ly,and Lx satisfy relations Y2<Ly and X2>Lx.

8. The pickup device according to claim 7, wherein the aforementioned Ly, Wy satisfy a relation Ly≧Wy, where Wy represents the width of the first and second detectors in the vertical direction of optical axis.

9. The pickup device according to claim 7, wherein a detection side of the first detector and a detection side of the second detector are arranged on different Z-coordinates, where Y-axis represents the vertical direction of the optical axis, X-axis represents the horizontal direction of optical axis, and Z-axis represents the direction of optical axis.

10. The pickup device as claimed in claim 1, characterized in that where dy represents a distance between an image surface in the vertical direction of the beam spot and a principal point of the toroidal lens, dx represents a distance between an image surface in the horizontal direction of the beam spot and the principal point of the toroidal lens, and D represents a distance between the detection side of the detector and the principal point of the toroidal lens,wherein the toroidal lens is a convex lens, f3y>f3x, and wherein dx, dy, and D satisfy a relation dx<D<dy.

11. The pickup device as claimed in claim 7, characterized in that where dy represents a distance between an image surface in the vertical direction of the beam spot and a principal point of the toroidal lens, dx represents a distance between an image surface in the horizontal direction of the beam spot and the principal point of the toroidal lens, and D represents a distance between the detection side of the detector and the principal point of the toroidal lens, wherein the toroidal lens is a concave lens, f3y>f3x, and wherein dx, dy, and D satisfy a relation dx>D>dy.

12. An optical recording apparatus configured for simultaneous recording, tracking, and reproduction for concurrent data recording and correction of data recording strategy, said recording apparatus comprising a laser diode and at least one beam splitter in the optical path of the laser diode output beam, wherein the at least one beam splitter is configured to split the beam from the laser diode into at least four beam spots that are simultaneously incident on optical recording media, said four beam spots providing beams for recording, reproduction, and tracking.

13. The apparatus of claim 12, wherein said beam splitter comprises one or more diffraction gratings.
